(19) United States
(12) Patent Application Publication
(10) Pub. No.: US 2009/0314127 A1
(43) Pub. Date: Dec. 24, 2009

(54) SIDE HILL EXTREME BAR ENDS

(76) Inventor: ADAM LONGNECKER, Snowmass Village, CO (US)

Correspondence Address: ADAM LONGNECKER, PO BOX 6858, 724 HAWK RIDGE LANE, SNOWMASS VILLAGE, CO, 81615, US

(21) Appl. No.: 12/486,731

(22) Filed: Jun. 17, 2009

Related U.S. Application Data
(63) Continuation of application No. 61/073,376, filed on Jun. 18, 2008.

(51) Int. Cl. B62K 21/26

(52) U.S. Cl. 74/551.9

(57) ABSTRACT

Side-hill extreme ergo grip bar ends comprising of an upright or ‘L’ shaped handle bar, ergo curves, and a screw attached to the handle bar, to provide safety, stability and additional leverage to the vehicle rider such as a snowmobiler while making hard turns and side hilling in the mountain slopes. Each bar end grip can be outfitted with an auxiliary throttle trigger. The auxiliary throttle mount is capable on either bar end grip or both bar end grips The ergo grip bar ends provide the snowmobiler the necessary space to accommodate his fingers covered by snow gloves and also provides space for attaching both from auxiliary throttle which can be triggered on inside grip of bar end or outside at bend of ‘L’ for safety and increased mobility. The ergo grip bar ends are made of stiff and strong material to accommodate heavy weight bearing. The top of the bend of ‘L’ contains a soft tip option to avoid discomfort if rider's leg were to come into contact.

### FIELD OF THE INVENTION

The present field of the invention is related to the operation of vehicle system for difficult terrains. More specifically, the invention is related to equipment used by a vehicle rider such as a snowmobiler when operating a snowmobile. Specifically, the present invention relates to an ergo grip adapted for use in a snowmobile for maintaining stability and throttle control.

### BACKGROUND OF THE INVENTION

A variety of different types of recreational vehicles have been developed and are used by sports enthusiasts. Specifically, in snow environments the recreational vehicle of choice is usually a snowmobile.

At least since the early 1960's snowmobiles have been used by sports enthusiasts in winter environments. Snowmobiles can travel on snow by the use of two front skis and a track somewhat similar to a tank track which runs from the back of the skis to the back of the snowmobile. The track is used to propel the snowmobile forward in the snow and the skis are used to change the direction of the snowmobile. Traditionally, snowmobiles have had a handlebar type steering mechanism instead of a steering wheel type steering mechanism. Usually on the snowmobile driver's right hand side when he is seated in the snowmobile seat is the throttle and on his left hand side is the brake. The right hand side of the handlebar usually has a handle grip adapted for engagement with the glove of the snowmobiler and a throttle which is adapted to be depressed to accelerate the snowmobile. The thumb of the driver's right hand engages the throttle. The left hand side of the handlebar can likewise have a brake which extends upwardly and is adapted to be depressed by the thumb or alternatively it can have a brake that extends parallel to the handlebar grip directly opposite the snowmobiler. Because the snowmobile is driven in a cold environment, the snowmobile operator is often wearing thick, heavy gloves. This additional padding around the fingers and the thumb of the snowmobiler can make operation of the throttle or the brake of the snowmobile slightly awkward.

Furthermore, operation of the throttle with the thumb requires substantial muscle strength in the thumb. Snowmobile operators who are not accustomed to operating snowmobiles often have tired muscles in their hands, fingers, especially the thumb, and wrist due to consistently maintaining the hand in a position to depress the throttle. This muscle discomfort is increased by the fact that the snowmobile operator must manipulate not only his thumb but the glove that is covering his thumb, which is often formed of a material such as leather which stiffens in the cold. There is a need to provide a grip bar that is adapted to engage the throttle of the snowmobile without unduly tiring the muscles in the hand of the snowmobiler.

Likewise, there is a need for a grip bar that is adapted to engage a snowmobile throttle which does not readily disengage the throttle when the snowmobile proceeds over bumps such as can often happen when the thumb portion of a snowmobile operator's glove is placed on the throttle of the snowmobile.

Further there is a need for a grip bar to add ease of use to snowmobiles when making hard turns and side hilling on slopes.

The relevant prior art methods, which will deal with various attachments for safe use of snow mobiles, are as follows:

US Patent Application No. 20030164258 explains about an air bag safety floatation system for vehicles in danger of sinking. The device is installed on a snow mobile on the handle bar and steering section thereof. The system comprises a CO2 cartridge with a supply line to fill an air bag, to allow the machine on which it is mounted to float for a sufficient period of time to allow the user to escape to safety. Importantly, this system may be activated manually through usage of a manual trigger mechanism, which may be armed by the user when traveling across frozen lakes or rivers, and disarmed by the user when in other areas. A locking pin is also utilized for the purposes of user safety. In addition, the system may be deployed through the use of a pressure switch, which is automatically activated upon being submerged into water. Once deployed, the device serves as a survival tool for those operating machines that fall through ice on lakes or rivers, preventing significant damage to the snow mobile in the process. Finally, the system inhibits the leakage of fluids such as gasoline and oil into the water, thereby providing additional safety and largely preventing pollution.

US Patent Application No. 20060010724 discloses an envelope of felt (or other fabric resistant to snow adhesion) into which a regular eighteen-twenty-two inch size snow shovel may be inserted, folded over to enclose the shovel and temporarily clasped in place by snaps or Velcro—and reinforceable in the area where the shovel blade would rest so as to afford optimal protection against marring the finish of a car or sport utility vehicle when the shovel handle is grasped in pushing snow from off the vehicle.

US Patent Application No. 20060131891 claims a method and apparatus for enabling a motorized vehicle to stop and/or start on ice and snow. More particularly the present invention relates to a method and apparatus which allows the driver of a motorized vehicle to safely come to a complete stop on icy/snowy roads without skidding and which also allows the driver of the motorized vehicle to move forward from a stopped position on icy and snowy roads without slippage between the wheels of the motorized vehicle and the road surface.

US Patent Application No. 20070216118 reveals a collapsible patient supporting carrier configured as either a backboard or a stretcher for being pulled or towed behind a person, animal or vehicle, such as a bicycle, motorcycle, snow mobile or jet ski. The carrier comprises a plurality of support sections interconnected by connecting mechanisms that are configured to selectively place the carrier in a collapsed condition having a support surface for carrying medical supplies or an extended condition for transporting an injured person. Each support section is made up of a frame and one or more support members, such as a rigid plate or a somewhat flexible material, attached to the frame. The forward end of the carrier has a tow connector member to connect to a tow member for towing. Transport members, such as wheels, skis or a floatation member, are operatively connected near the second end of the carrier to facilitate movement over a surface.

US Patent Application No. 20080023980 describes a windshield stabilizing apparatus comprising two pairs of suction cup assemblies adjustably connected to a horizontal elongated tether or nylon fence which pivotally connects to the right and left sides of the snow mobile windshield adding lateral support increasing stability and rigidity. By connecting each side of the windshield, added stability is achieved for the rider at high and low speeds. The stabilizing device can be disconnected by the release of the tether hook located in the middle of the tension tether.

However the purpose and methodology of the above inventions are part of prior art do not envisage ergonomic grip bar ends. They also do not address the comfort of the rider. The present invention differs from the existent prior art in that it uses the ergo grip bar end comprising of a pliable outer cover with a malleable inner core. In an alternate embodiment, the ergo grip bar end may be comprised of a single material, which serves as both the outer cover and the inner core.

Further, the present invention comprises the bar ends which provide additional leverage and movement from side to side when riding snowmobile on Side-hill. Also, the rider will be able to hang his/her body weight further away from the machine while turning the sled up on one ski in deep powder snow or on a Side-hill.

### SUMMARY OF THE INVENTION

This invention may be summarized, at least in part, with reference to its objects.

The primary object of the present invention is to ease of use to snowmobiles when making hard turns and side hilling on slopes.

It is another object of the present invention to provide a comfortable ergonomic handle at the end of vehicle handle bars.

It is another object of the present invention to provide additional leverage through the bar ends while riding on Side-hill.

It is another object of the present invention is to provide a strong hold for users of snowmobiles in steep mountain terrain.

It is another object of the present invention to provide movement from side to side so that the rider can be able to hang his/her body weight further away from the machine.

It is another object of the present invention to provide grip with the auxiliary throttle mounted on inside grip of bar end or outside at bend of ‘L’, thus allowing the user to control the throttle of the snowmobile from the grip.

Yet another object of the present invention is to provide an accessory to a snowmobile which gives the operator superior stability for improved performance.

These and other objects of the present invention will be more readily apparent when considered in reference to the following description and when taken in conjunction with the accompanying drawings.

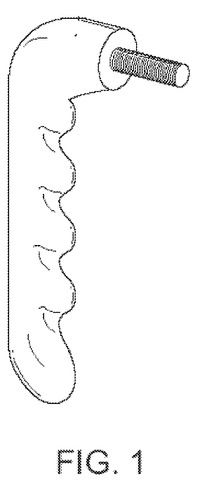

FIG. 1 is a perspective diagram of the outer end of the ergo grip bar.

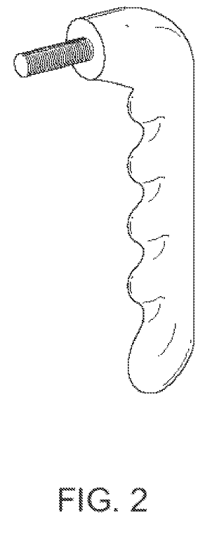

FIG. 2 is a perspective diagram of the inner end of the ergo grip bar.

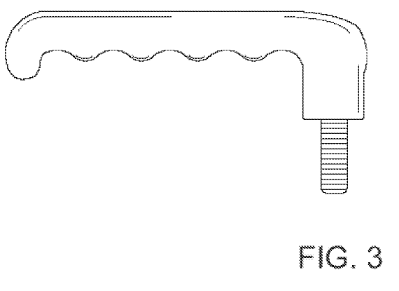

FIG. 3 is a side perspective diagram of the ergo grip bar.

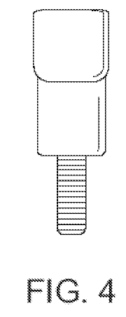

FIG. 4 is a front perspective diagram of the ergo grip bar.

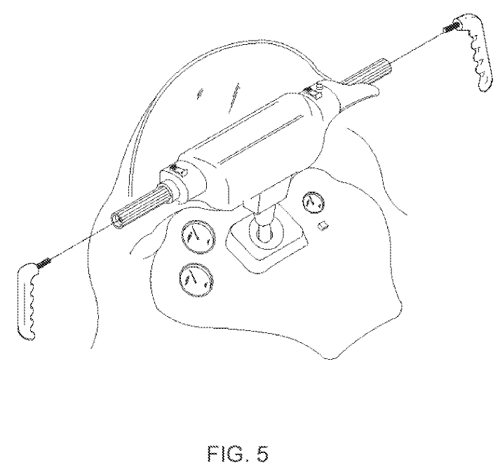

FIG. 5 is a perspective diagram of the mechanism of fitting the ergo grip bar into the conventional handle bar.

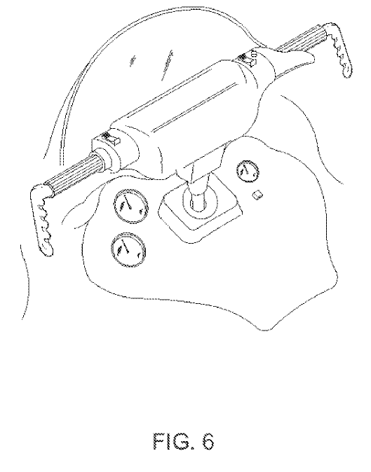

FIG. 6 is a perspective diagram of the fitted ergo grip bar into the conventional handle bar.

### DETAILED DESCRIPTION OF THE INVENTION

The following description is presented to enable any person skilled in the art to make and use the invention, and is provided in the context of particular applications of the invention and their requirements. The present invention can be configured as follows:

The preferred embodiment ergo grip bar ends according to the present invention is formed from a particular material, and fashioned in such a manner that a unique combination of properties relating to both stability and control over the vehicle are achieved. The preferred embodiment ergo grip bar ends using the materials of construction described herein, can also feature the particular shape and configuration as shown in the referenced figures. These and other aspects are described in greater detail herein.

The preferred embodiment ergo grip bar ends comprises of an auxiliary handle bar designed to resemble an inverted “L” shaped ergo grip handle bar, ergo curves and screws for attachment. The preferred embodiment comprises of a pliable outer cover with a malleable inner core. In an alternate embodiment, the ergo grip bar end may be comprised of a single material, which serves as both the outer cover and the inner core. Structural characteristics of the ergo grip bar may also be controlled by adjustment of the material density. The outer surface and the inner surface of the ergo grip bar end is fashioned to provide a non slip surface offering more comfort and stability to the snowmobile user. The measurements of the ergo grip bar end are designed to suit the existing conventional snowmobile and in a fashion to offer improved grip to the snow mobile user while taking sharp turns and steep slides.

Each bar end grip can be outfitted with an auxiliary throttle trigger. The auxiliary throttle mount is capable on either bar end grip or both bar end grips. The ergo grip bar ends provide the snowmobiler the necessary space to accommodate his fingers covered by snow gloves and also provides space for attaching both from auxiliary throttle which can be triggered on inside grip of bar end or outside at bend of ‘L’ for safety and increased mobility.

The ergo grip bar end is in the form of a “L” bar, the interior side of which is shaped in to a deep curves that are capable of accommodating the fingers of the user which is wrapped inside an insulated snow glove. The ergo curves offer the grip to the snow mobile user while taking a deep slide or sharp turn thereby allowing the user to maintain his personal stability as the user can fit his fingers in to the curves easily and can hold on to it as it is not slippery. The ergo grip bar ends are made of stiff and strong material to accommodate heavy weight bearing. The top of the bend of ‘L’ bar end contains a soft tip option at the end of the long side of the L, bottom end of L when inverted, to avoid discomfort if rider's leg were to come into contact.

The screw present to fasten the present invention to the existing handle bar is designed to fit into the conventional handle bar of the snowmobile. The ergo grip bar end can be screwed tightly into the conventional handle to give a steady support to the user of the snowmobile. User places hand on ergo grip bar end for added leverage in turning.

Bar Ends in the present invention provide additional leverage when riding snowmobile on Side-hill. The present invention also provides space for mounting the auxiliary throttle and the auxiliary throttle attachment can be mounted to access throttle trigger on inside grip of bar end or outside at bend of ‘L’. This accessory arrangement allows the user of the snow mobile to control the throttle of the snow mobile from the grip. This accessory arrangement is made as a safety measure for the user who can control the speed of the snow mobile by placing his hands on the handle itself. This avoids the risk of meeting with accidents while taking deep slides and sharp turns due to lose of control over the speed of the vehicle.

Further, the present invention provides the auxiliary throttle mount capable on either bar end grip or both bar end grips. This aspect of the invention provide the snowmobile rider with additional leverage and movement from side to side, for example when a snowmobile rider is turning the sled up on one ski in deep powder snow or on a side-hill the rider will be able to hang his/her body weight further away from the machine.

It will be apparent to those skilled in the art that the objects of this invention have been achieved by providing ergo grip bar ends. Various changes may be made in the structure of the ergo grip bar ends. Further, features of some components disclosed in this application may be employed with features of other embodiments. Therefore, the scope of the invention is to be determined by the terminology of the following claims and the legal equivalents thereof.

What is claimed is:

1. Side-hill extreme bar ends comprising of a ‘L’ shaped handle bar that can be placed in an inverted fashion, ergo curves, and a screw attached to the handle bar, characterized in that said ergo grip bar ends can be made of a pliable outer cover with a malleable inner core.

2: The bar ends as claimed in claim 1 wherein the said ergo grip bar ends can be made of a pliable outer cover with a malleable inner core.

3. The bar ends as claimed in claim 1 wherein the said ergo grip bar ends are made of stiff and strong material.

4. The bar ends as claimed in claim 1 wherein said ergo grip bar ends contains a soft tip option at the end of the long side of the L, bottom end of L when inverted,.

5. The bar ends as claimed in claim 1 wherein the said ergo grip bar ends can be made of a single material, which serves as both the outer cover and the inner core.

6. The bar ends as claimed in claim 1 wherein the said ergo curves are crafted to accommodate the fingers of the user wrapped inside an insulated snow glove.

7: The bar ends as claimed in claim 1 wherein the said ergo grip bar ends are screwed into the conventional handle.

8. The bar ends as claimed in claim 1 wherein space is provided for mounting an auxiliary throttle on the inside grip of said ergo bar end or outside at bend of ‘L’.

9. The bar ends as claimed in claim 1 wherein an auxiliary throttle trigger mount is capable on either bar end grip or both bar end grips.

10. The bar ends as claimed in claim 1 wherein said ergo grip bar ends contain space for attaching said auxiliary throttle which can be triggered on inside grip of said bar end or outside at said bend of ‘L’.
